(19) United States
(12) Patent Application Publication
(10) Pub. No.: US 2023/0133677 A1
(43) Pub. Date: May 4, 2023

(54) PHYSICAL (PHY) LAYER DESIGN FOR HYBRID AUTOMATIC REPEAT REQUEST (HARQ) IN WIRELESS LOCAL AREA NETWORK (WLAN) SYSTEM

(71) Applicant: InterDigital Patent Holdings, Inc., Wilmington, DE (US)

(72) Inventors: Li Hsiang SUN, San Diego, CA (US); Hanqing LOU, Syosset, NY (US); Rui YANG, Greenlawn, NY (US); Xiaofei WANG, North Caldwell, NJ (US)

(21) Appl. No.: 17/911,073

(22) PCT Filed: Mar. 11, 2021
(86) PCT No.: PCT/US2021/021948

§ 371 Date: Sep. 12, 2022

Related U.S. Application Data
(60) Provisional application No. 62/989,274, filed on Mar. 13, 2020.

(51) Int. Cl. H04L 1/00

(52) U.S. Cl. CPC H04L 1/0041; H04L 1/0083; H04L 1/0057

(57) ABSTRACT

A method to transmit data from a wireless apparatus includes determining an information block length corresponding to an error correction code, inserting padding bits into at least one protocol data unit, PDU, of a plurality of PDUs such that a padded PDU size is an integer multiple of the determined information block length, and wherein each PDU in a frame of PDUs to be transmitted comprises a PDU size that is an integer multiple of the determined information block length, and transmitting the frame encoded by the error correction code with the determined information block length to a wireless receiver.

### CROSS REFERENCE TO RELATED APPLICATIONS

This application claims the benefit of U.S. provisional patent application No. 62/989,274 filed 13 Mar. 2020 which is incorporated by reference herein in its entirety for all purposes.

### BACKGROUND

Hybrid Automatic Repeat Request (HARQ) is used in 5G networks. A HARQ-like mechanism is also desirable for wireless local area network (WLAN)s. IEEE 802.11 standards were not initially designed to have HARQ capability. Advances and developments of the IEEE 802.11 standard invite a HARQ capability to accommodate efficient retransmission of information received with errors. However, practical implementation of a HARQ-like capability in a WLAN is challenged with considerations of detection of protocol data units for correction and the use of aggregated protocol data units used for efficient transmission over wireless networks. Thus, new methods are needed to accommodate HARQ in a WLAN using IEEE 802.11 protocols.

### SUMMARY

In one embodiment, a method to align sizes of Protocol Data Units (PDUs) in a plurality of PDUs with lengths of corresponding information blocks of an error correction code for a wireless transmission includes determining an information block length corresponding to the error correction code, inserting padding bits onto at least one PDU of the plurality of PDUs to align a padded PDU size with an integer multiple of the determined information block length. Each PDU size in a frame of PDUs is likewise aligned to an integer multiple of the determined information block length. The frame of PDUs is encoded by the error correction code with the determined information block length and transmitted to a wireless receiver.

Although various embodiments are described and/or claimed herein in which an apparatus, system, device, etc. and/or any element thereof carries out an operation, process, algorithm, function, etc. and/or any portion thereof, it is be understood that any embodiments described and/or claimed herein assume that any apparatus, system, device, etc. and/or any element thereof is configured to carry out any operation, process, algorithm, function, etc. and/or any portion thereof.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures and the detailed description are not to be considered limiting, and other equally effective examples are possible and likely. Furthermore, like reference numerals (“ref”) in the Figures indicate like elements, and wherein:

FIG. 1A is a system diagram illustrating an example communications system in which one or more disclosed embodiments may be implemented;

FIG. 1B is a system diagram illustrating an example WTRU that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 depicts an example HE SU PPDU format;

FIG. 3 depicts an example HE MU PPDU format;

FIG. 4 depicts an example HE ER SU PPDU format;

FIG. 5 depicts an example HE TB PPDU format;

FIG. 6 depicts an example EHT PPDU Preamble Structure;

FIG. 7 depicts an example data scrambler;

FIG. 8 depicts an example HE PPDU padding process in the last OFDM symbol (non-STBC);

FIG. 9 depicts and example procedure to perform LDPC encoding based on individual MPDU in an A-MPDU frame;

FIG. 10 depicts an example procedure to perform LDPC encoding based on a MPDU which has maximum length (size) among MPDUs in an A-MPDU frame;

FIG. 11 depicts an example procedure to perform MPDU and CW (information block) boundary alignment by using PHY layer padding;

FIG. 12 depicts an example of LDPC codeword (information block) length selection with MPDU and CW boundary alignment encoding procedure;

FIG. 13 depicts an example flow diagram for a method of the disclosure;

FIG. 14 depicts an example HARQ sequence number provided by a receiver Rx;

FIG. 15 depicts an example reversed order of FEC and scrambler at a transmitter Tx;

FIG. 16 depicts an example reversed order of FEC and scrambler at a receiver Rx.

Table 1 presents example L-SIG Field lengths;

Table 2 present example HE-SIG-A Fields for Different PPDUs.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application. In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein.

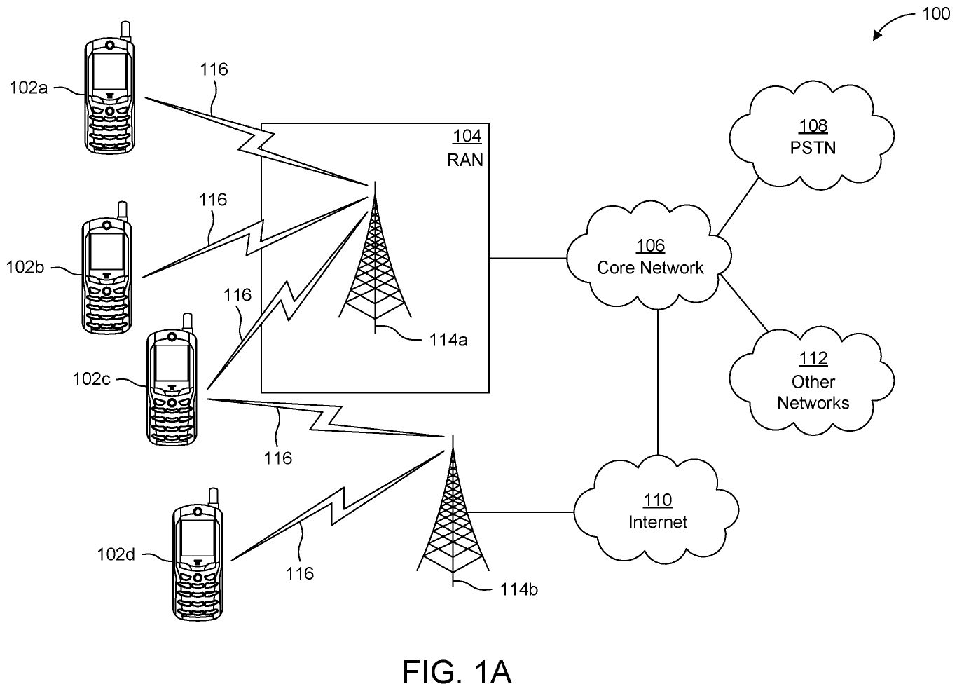

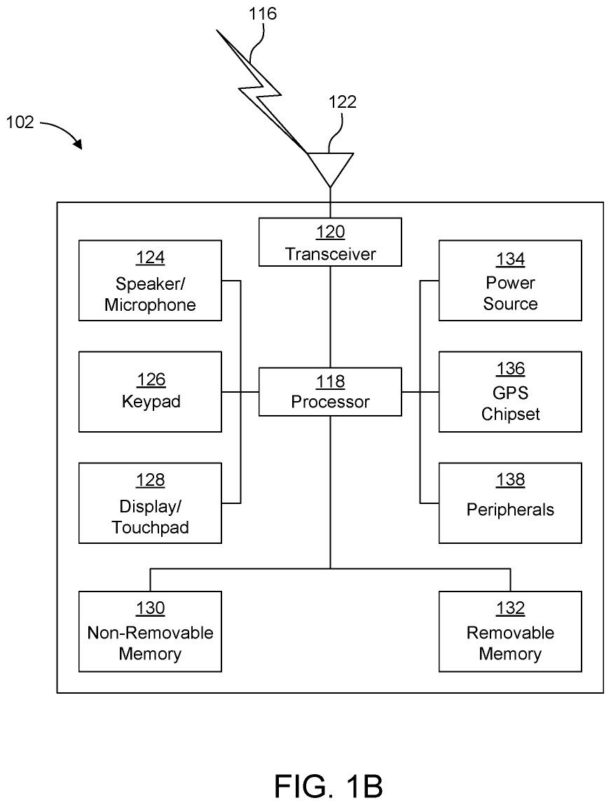

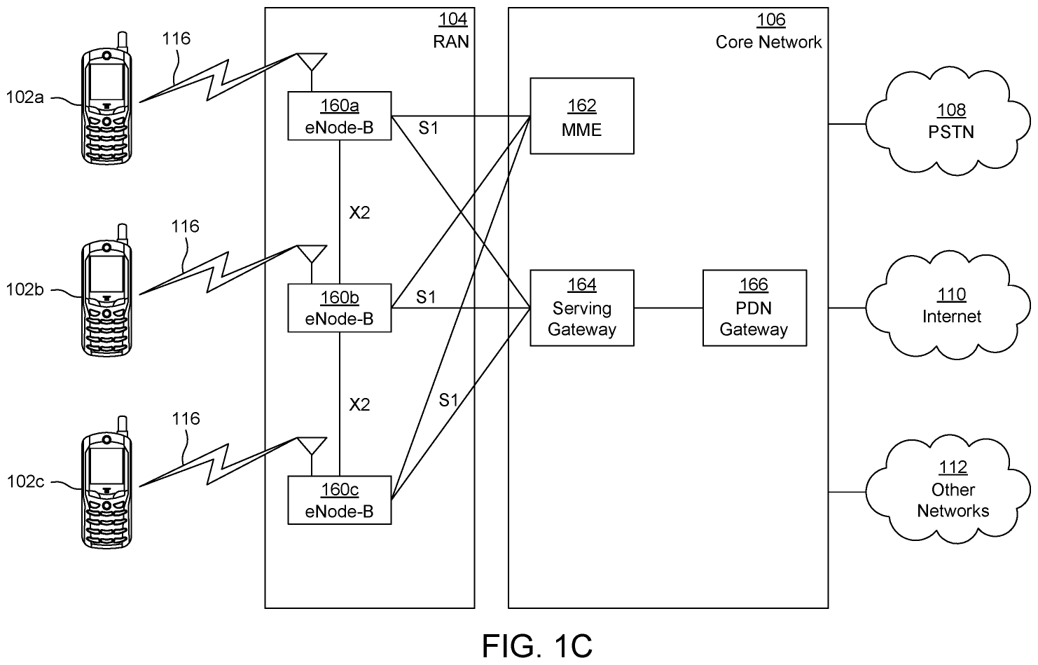

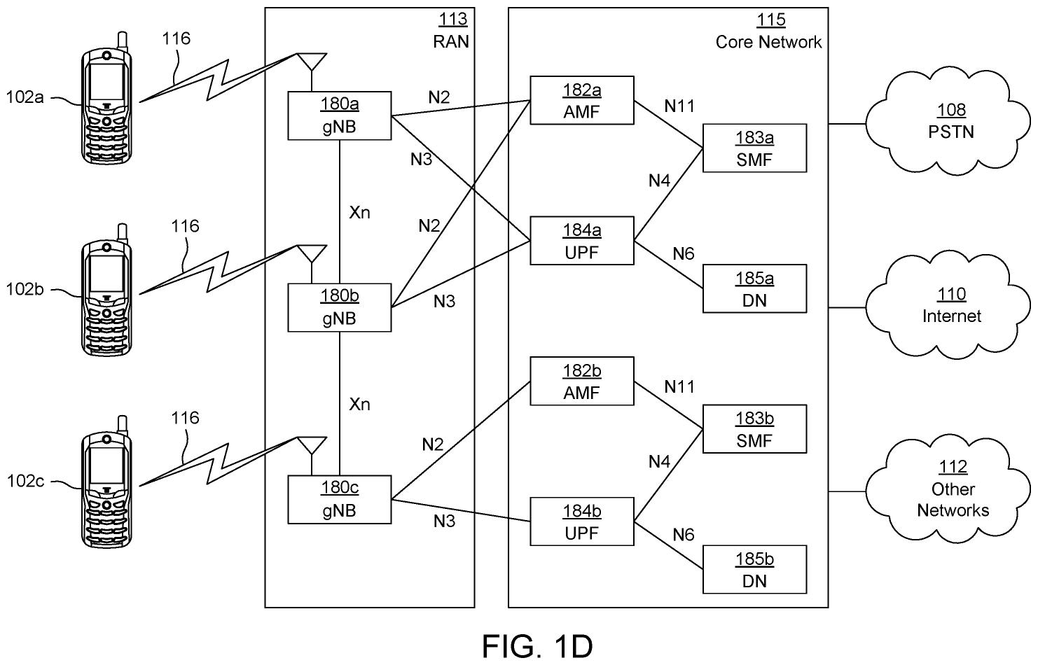

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of (non-access stratum) (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU/UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples provided herein do not limit applicability of the subject matter to other wireless technologies, e.g., using the same or different principles as may be applicable.

As explained herein, a wireless transmit receive unit (WTRU) may be an example of a user equipment (UE). Hence the terms UE and WTRU may be used in equal scope herein. Additionally, a UE may also be termed a station (STA) when used in a WLAN environment where radio technologies such as IEEE 802.11 are used.

Overview of WLAN System

A WLAN in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where the source STA sends traffic to the AP and the AP delivers the traffic to the destination STA.

Using the IEEE 802.11ac infrastructure mode of operation, the AP may transmit a beacon on a fixed channel, usually the primary channel. This channel may be 20 MHz wide, and is the operating channel of the BSS. This channel is also used by the STAs to establish a connection with the AP. The fundamental channel access mechanism in an IEEE 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In IEEE 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In IEEE 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to IEEE 802.11n described above. A 160 MHz channel may be formed either by combining 8 contiguous 20 MHz channels, or by combining two non-contiguous 80 MHz channels, this may also be referred to as an 80+80 configuration. For the 80+80 configuration, the data, after channel encoding, is passed through a segment parser that divides it into two streams. Inverse Fast Fourier Transform (IFFT), and time domain, processing are done on each stream separately. The streams are then mapped on to the two channels, and the data is transmitted. At the receiver, this mechanism is reversed, and the combined data is sent to the MAC.

To improve spectral efficiency IEEE 802.11ac has introduced the concept for downlink Multi-User Multiple Input Multiple Output (MU-MIMO) transmission to multiple STA's in the same symbol's time frame, e.g. during a downlink Orthogonal Frequency-division Multiplexing (OFDM) symbol. The potential for the use of downlink MU-MIMO is also currently considered for IEEE 802.11ah. It is important to note that since downlink MU-MIMO, as it is used in IEEE 802.11ac, uses the same symbol timing to multiple STA's interference of the waveform transmissions to multiple STAs, then downlink MU-MIMO is not an issue. However, all STA's involved in MU-MIMO transmission with the AP must use the same channel or band, this limits the operating bandwidth to the smallest channel bandwidth that is supported by the STA's which are included in the MU-MIMO transmission with the AP.

IEEE 802.11ax Physical Layer Protocol Data Unit (PPDU)

IEEE 802.11ax defines a physical layer specification and medium access control layer specification that enables High Efficiency (HE) operation for IEEE 802.11 devices. IEEE 802.11ax is considered a next main generation of Wi-Fi after IEEE 802.11ac. IEEE 802.11ax defined new numerology with smaller subcarrier spacing. Downlink/Uplink (DL/UL) OFDMA is introduced in IEEE 802.11ax to achieve better spectrum efficiency.

In IEEE 802.11ax, four PPDU formats are supported:

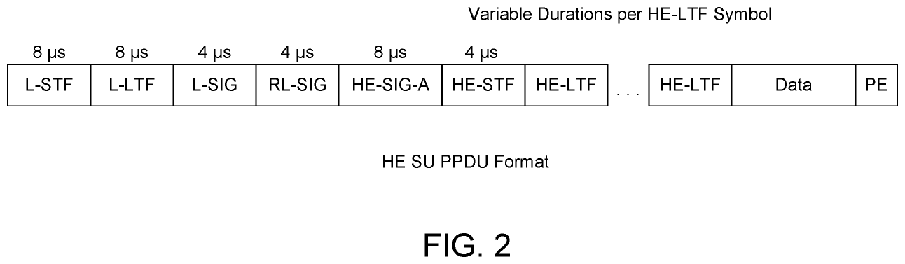

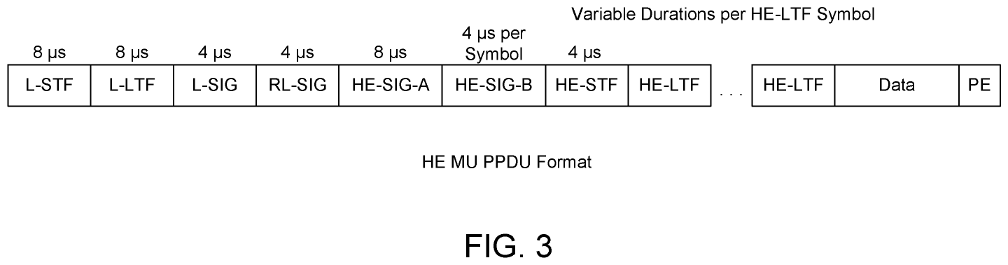

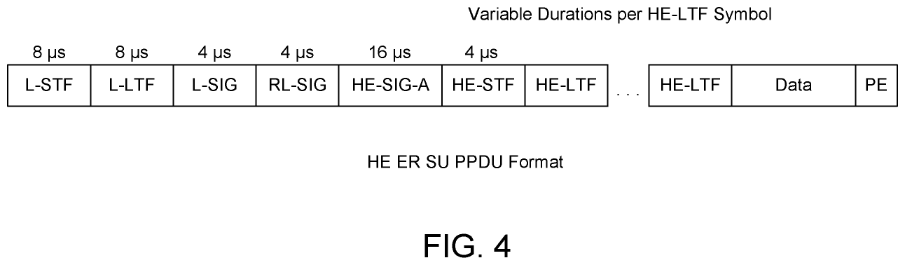

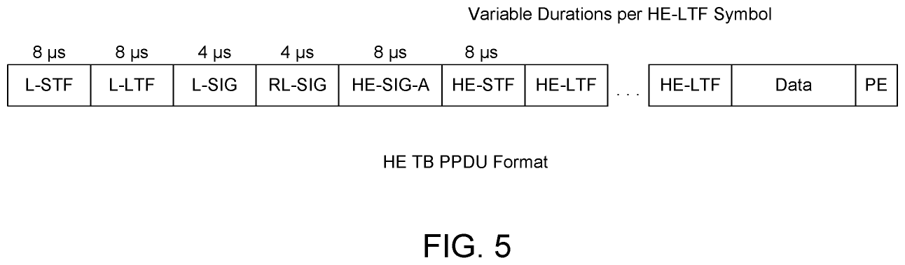

a. High Efficiency Single User PPDU (HE SU PPDU): this PPDU format is used for single user transmission. Refer to FIG. 2 for the HE SU PPDU format.
b. High Efficiency Multiple User PPDU (HE MU PPDU): this PPDU format is used for transmissions to one or more users if the PPDU is not a response of a Trigger frame. The High Efficiency Signal Field-B (HE-SIG-B) field is presented in the PPDU format of FIG. 3.
c. High Efficiency Extended Range Single User PPDU (HE ER SU PPDU): This PPDU format is used for SU transmission with extended range. In this format, the HE-SIG-A field is twice as long as the High Efficiency Signal Field-A (HE-SIG-A) field in other HE PPDU formats. Refer to FIG. 4 for the HE ER SU PPDU format.
d. High Efficiency Trigger-Based PPDU (HE TB PPDU): this PPDU format is used for a transmission that is a response to the Trigger frame or a frame carrying a Triggered Response Scheduling (TRS) control subfield from an AP. The duration of the High Efficiency-Short Training Field (HE-STF) field in the HE TB PPDU is Bus, which is double the size of that in other HE PPDU formats. Refer to FIG. 5 for the HE TB PPDU format.

Legacy Signal (L-SIG) field, HE-SIG-A field and HE-SIG-B field carry Physical (PHY) layer control information for the PPDU. The L-SIG field has a legacy numerology and format, so that all the STAs understand L-SIG field. HE-SIG-A field and HE-SIG-B field are understood by HE STAs. L-SIG fields are given in Table 1. HE-SIG-A fields for different PPDU formats are given in Table 2.

IEEE 802.11be PPDU Design

The IEEE Standard board approved the IEEE 802.11be Task Group (TG) based on a Project Authorization Request (PAR) and Criteria for Standards Development (CSD) developed in the Extremely High Throughput Study Group (EHT SG).

SIG Fields

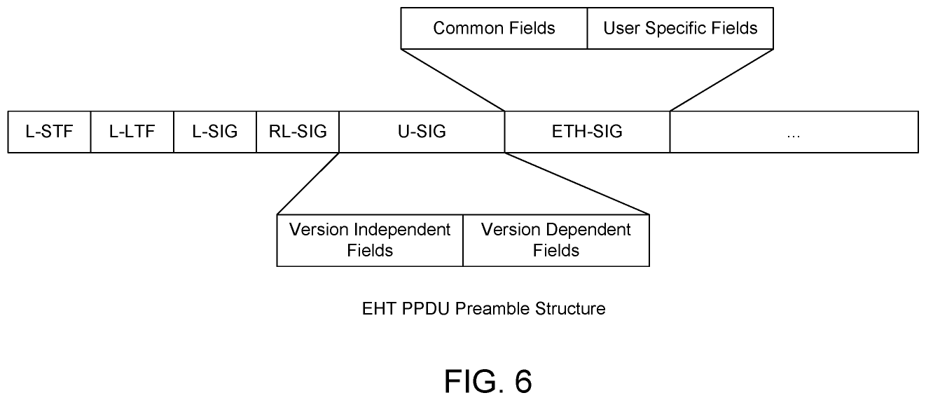

Task Group for IEEE 802.11be (TGbe) has agreed that the Extremely High Throughput (EHT) PPDU will have the preamble structure shown in FIG. 6. The U-SIG (Universal Signal field) includes version independent and version dependent bits. The bits in the version independent fields will have static location and bit definition across different generations/PHY versions. The version independent bits may include PHY version identifier, UL/DL flag, BSS color, and transmit opportunity (TXOP) {duration, bandwidth information, etc.}. The version dependent bits may include PPDU type. Combined with Common Fields in EHT-SIG, the version dependent fields may also include Modulation and Coding Scheme (MCS), Number of space time streams, Guard Interval+Extreme High Throughput+Long training Field (GI+EHT−LTF) side, coding, etc. User Specific Fields may be used in a MU configuration. The IEEE 802.11be may not have separate PPDU formats for SU and MU but have a single PPDU format for both SU and MU.

Objective/Problem Statements

Objective/Problem 1: MAC Protocol Data Unit (MPDU) and Codeword (CW) Alignment

The Hybrid Automatic Repeat Request (HARQ) retransmission unit and acknowledgement unit should be defined clearly to enable HARQ mechanisms. In the current standard, a frame check sequence (FCS) is inserted at the end of a MAC layer frame, i.e., MPDU. A STA may check the FCS to determine if it receives the MPDU correctly and responds with an acknowledgement. MPDUs may be aggregated in the MAC layer and passed to the PHY layer. With the currently available design, the PHY layer may perform channel coding without knowing the boundary of the MPDUs. However, HARQ combination may be based on a codeword (CW), which depends on a PHY layer channel coding procedure. Thus, an MPDU and a codeword which are not aligned, which may introduce problems for HARQ retransmissions and acknowledgements.

Objective/Problem 2: Scrambler & Identifying Failed Sections

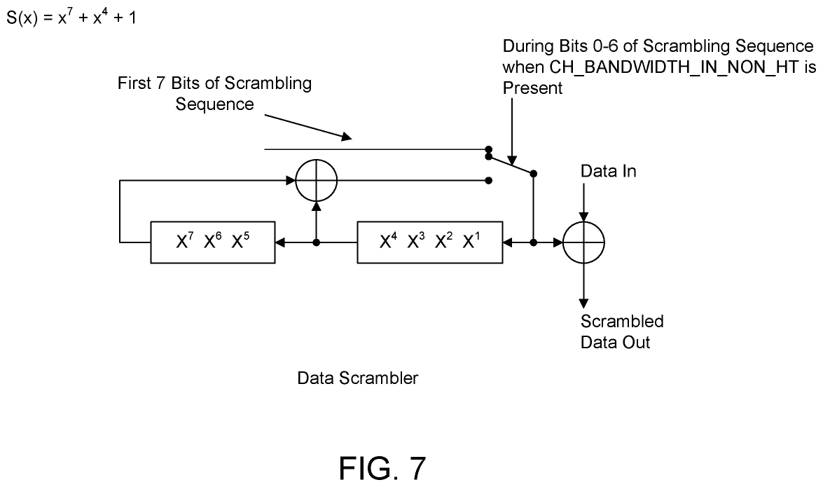

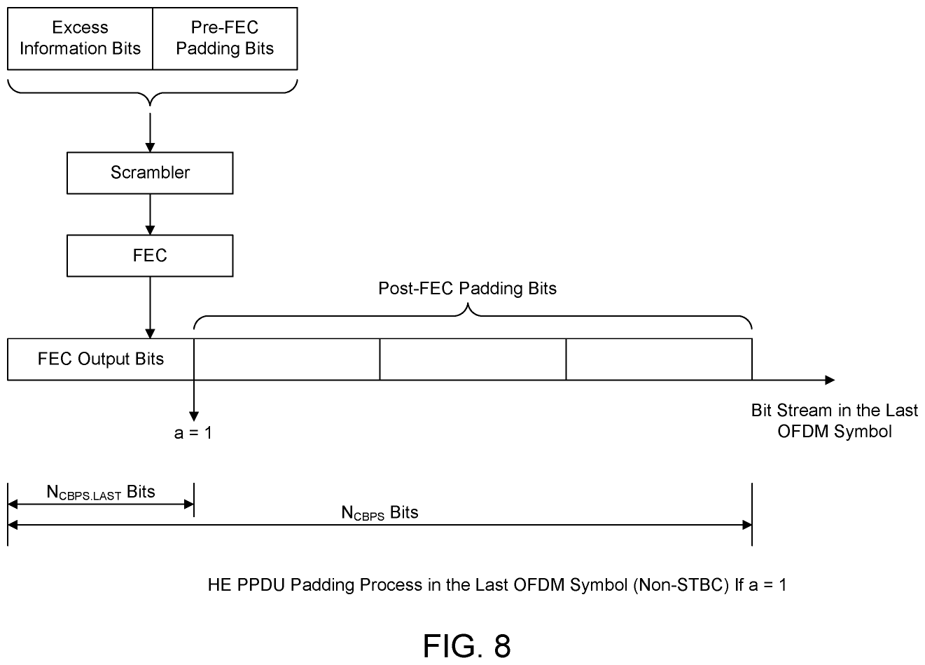

An IEEE 802.11 ax data field scrambler and procedure is shown in FIG. 7. The PHY layer operation which includes the scrambler is shown in FIG. 8. The scrambling is performed before the forward error correction (FEC) process.

For an Aggregated MAC Protocol Data Unit (A-MPDU), the scrambling is performed using a 7-bit seed and the bit sequence (scrambling sequence) used to scramble an MPDU is dependent on the position of the MPDU in the A-MPDU. It is determined by the scrambler state x¹, . . . , x⁷ when the 1st bit of the MPDU is shifted into the scrambler.

For the 1st HARQ transmission, the receiver can descramble the output bits of the FEC decoder based on the SERVICE field and the offset d (in bits) from the start of the A-MPDU, to extract the MPDU and to perform FCS check. However, for the reception of HARQ retransmissions, the receiver will not be able to descramble the FEC output bits (after the HARQ combining process) without remembering the scrambler state associated to the FEC output, which is derived from the offset d and the scrambler seed of the original A-MPDU.

Signaling is needed to enable the receiver to reconstruct the scrambling sequence which was used to scramble a section of the uncoded bits in the original A-MPDU.

For non-HARQ reception, the size of buffer for the log-likelihood ratio (LLR) softbits is related to the CW size (e.g. several CWs). With HARQ reception, the size of the buffer needs to increase to accommodate multiple failed CWs in one or more A-MPDUs. It may not be possible to design a HARQ buffer that is large enough to handle the maximum length (size) of an A-MPDU. It has been estimated that only 13˜26% of CWs require storage, and the HARQ buffer does not need to have the size to handle the worst case.

There are two ways for the transmitter to associate the HARQ retransmitted sections to the positions in the original A-MPDU.

1. Based on the section positions (offset d, e.g. byte position, CW position) of the original A-MPDU:
In this case, the receiver would need to remember d of the failed sections, and the scrambling seed of the A-MPDU, or the scrambler state at the beginning of the failed section. In the retransmission the transmitter would need to signal the position of retransmitted section in the original A-MPDU, which would incur an overhead, e.g.

$$\sim {log}_{2} ⌈ \frac{max\_AMPDU \_size \times 8}{CW\_size \times Code\_rate} ⌉ ,$$

plus another overhead of identifying the original A-MPDU.
If the receiver chooses not to remember the (initial) scrambler state, then this information has to be signaled by the transmitter in the retransmission.
2. Based on an identifier signaled by the receiver to identify the failed section: A receiver may include an identifier in the HARQ feedback/block acknowledgement (BA), which could be used in the signaling of retransmission. The size of the identifier is e.g.

$$\sim {log}_{2} ⌈ \frac{HARQ\_buf \_size}{CW\_size} ⌉ ,$$

which has a smaller retransmission signaling overhead. If the receiver chooses not to remember the (initial) scrambler state, then this information has to be signaled by the transmitter in the retransmission.

Note for method 2 above, the receiver does not need to keep track of the position of a failed section in the original A-MPDU. If the receiver does not maintain the scrambler state, the transmitter will have to signal the scrambler state (or the position d+initial scrambler seed) for each retransmitted section.

The methods above describe how the transmitter identifies the association of the retransmitted data with the original transmission (based on the offset of the original A-MPDU or a receiver specified number). However, the receiver's HARQ feedback in the method 1 which may only feed back the correctly received MPDUs, has already been proposed. For such a case, a transmitter would not know whether the receiver has allocated LLR buffer and stored LLR for the sections containing the missed MPDUs. When the transmitter is to perform retransmission, a self-decodable retransmission is preferred in case the receiver has no LLR buffered. Such a method has already been proposed. The MCS of the retransmission could potentially be independent. However, the retransmission must use the same scrambler seed as the 1st transmission, and this needs to be signaled separately for each retransmitted section.

For either methods above, it would be desirable to reduce the state information that needs to be maintained by the receiver, and to optionally enable self-decodable retransmission, so that the receiver does not need to maintain the scrambler state information. It would also be desirable to reduce signaling overhead such that the transmitter signals just one (initial) scrambler state which can be used in all retransmitted HARQ sections or the additional new MPDUs in the retransmitted A-MPDU.

Objective/Problem 3: HARQ Buffer Status

A HARQ buffer is needed at both the transmitter and the receiver side for HARQ transmissions. It is important that the HARQ originator knows if the failed transmission was buffered at the receiver side so it may plan its retransmission. For example, if the failed transmission was not buffered, the originator may retransmit a self-decodable version. Mechanisms and methods should be provided to make HARQ originator know the buffer status of the receiver.

Proposed Solutions

### Embodiment 1: MAC Protocol Data Unit (MPDU) and Codeword (CW) Alignment

The utility of the methods disclosed herein need not be limited to particular layers of a wireless device. Thus, structures such as MPDUs and A-MPDUs may be considered protocol data units and frames of a plurality of PDUs respectively. In the following descriptions, embodiment examples involving MPDUs and A-MPDUs are used as a specific example, but the concepts need not be limited to such specific layers. Methods and procedures disclosed here may be used to address objective/problem 1. In this embodiment, several methods are disclosed to align the MPDU boundary with the codeword boundary.

An aggregated MPDU (A-MPDU) is assumed to be passed from the MAC layer to the PHY layer, and in the PHY layer the encoding procedure may introduce multiple codewords. One or more of following changes to parameters in IEEE 802.11 may be needed to align the MPDU and the CW boundary:

a. A TXVECTOR parameter may include MPDU lengths (sizes) in an A-MPDU frame. A TXVECTOR parameter is an internal vector passed from MAC layer to PHY layer within a device. This vector sets necessary PHY layer parameters to enable a PPDU transmission. In the methods herein, a TXVECTOR parameter includes not only the A-MPDU length, but also each individual MPDU length (size).
b. HARQ SIG may include MPDU lengths (sizes) so that an RXVECTOR parameter may set those values properly. An RXVECTOR parameter is an internal vector passed from PHY layer to MAC layer within a device. This vector carries information about the received PPDU parameters. In the methods herein, a RXVECTOR parameter includes not only the A-MPDU length, but also each individual MPDU length (size).

Note, MPDU lengths or sizes are mentioned in the above procedures. However, it may be replaced by HARQ unit lengths or sizes. A HARQ unit may refer to the unit for retransmission and/or acknowledgement, for example, an MPDU. Note MPDU length is expressed in the unit of Bytes.

Method I

In this method, an MPDU may be used as the unit onto which an information block may be applied. In one example, the MPDU is a unit used to perform a low-density parity-check (LDPC) coding procedure, and the procedure may be repeated for all the MPDUs in the A-MPDU. In this way, each MPDU may have its own information block length, for example an LDPC codeword length (CW length or information block length). As used herein, the term codeword is synonymous with an information block.

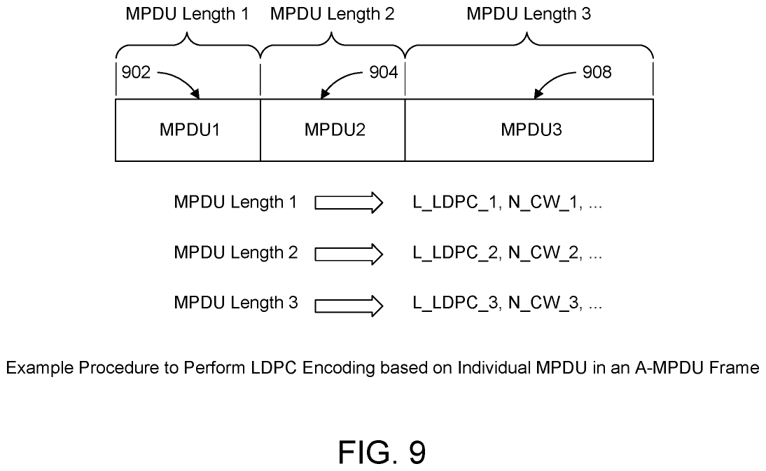

The exemplary procedure for single user (SU) transmissions is given below. See FIG. 9 for an example. In FIG. 9, three MPDUs have three different lengths or sizes; MPDU1 labeled as 902 has length 1, MPDU2 labeled as 904 has length 2, and MPDU3 labeled as MPDU3 has length 3. The procedure for Method 1 includes:

a. For the kth MPDU, calculate an initial number of OFDM symbols for the MPDU using the below equation. Note that MPDU_Lengthₖ is used to replace the Aggregate MAC protocol data unit (A-MPDU) pre-end of frame (EOF) padding (APEP)_length expressed in the published technique of “IEEE P802.11ax™/D3.0, Amendment 6: Enhancements for High Efficiency WLAN”, 2018. In the above-mentioned D3.0, Amendment 6 publication, note that MPDU_Lengthₖ is used to replace APEP_length.

$${N}_{SYM , init , k} = {m}_{STBC} \cdot \frac{8 \cdot {MPDU\_Length}_{k} + {N}_{tail} + {N}_{service}}{{M}_{STBC} {N}_{DBPS}}$$

b. Calculate N_{lpd,k} the number of information bits that can be carried within N_{SYM,init,k} OFMD symbols as shown in the above-mentioned D3.0, Amendment 6 publication. Note, N_{SYM,init} is replaced with N_{SYM,init,k} in the calculation.
c. Calculate N_{avbits,k} the number of coded bits can be carried within N_{SYM,init,k} OFMD symbols as shown in the above-mentioned D3.0, Amendment 6 publication. Note, N_{SYM,init} is replaced with N_{SYM,init,k} in the calculation.
d. The LDPC Extra Symbol Segment field may be set per MPDU based on N_{SYM,init,k} LDPC codeword length and the number of LDPC codewords may be selected and calculated on a per MPDU basis. Other LDPC parameters and procedures, such as shortening, puncturing, etc. may be calculated and performed on a per MPDU basis.

With this method, each MPDU may use up a whole number of OFMD symbols. Another MPDU boundary may align with a CW boundary and also an OFDM symbol boundary. An MPDU delimiter defined in an A-MPDU frame may be omitted and some signaling may be moved to PHY layer signaling.

PHY layer signaling may be modified to include one or more of below subfields:

a. More LDPC Extra Symbol Segment fields may be carried and each may be related to an MPDU. In one method, one LDPC Extra Symbol Segment field may be included in a mandatory SIG field, e.g., U-SIG or EHT SIG field. The rest of LDPC Extra Symbol Segment fields may be carried in an Extra SIG field. These parameters may be optionally included in a TXVECTOR parameter.
b. More Pre-FEC Padding Factor fields may be carried and each may be related to an MPDU. In other words, each MPDU may have a whole number of OFDM symbols. At the end of each MPDU, a packet extension (packet bit padding) may be applied for HARQ implementation. A Pre-FEC Padding Factor field for that MPDU may indicate the packet extension (packet bit padding) for that MPDU. In one method, one more Pre-FEC Padding Factor field may be included in a mandatory SIG field, e.g., U-SIG or EHT SIG field. Additional Pre-FEC Padding Factor fields may be carried in an Extra SIG field. Note, this field may enable per MPDU packet extension (packet bit padding) and may be applied to both LDPC and Block Convolution Code (BCC). These parameters may be optionally included in TXVECTOR parameter.

Method II

In this method, the MPDU which has the maximum length or size among MPDUs in an A-MPDU may be used as a unit length or size onto which to information blocks are calculated. In one example, the MPDU size may be used as a unit size to calculate LDPC error correction parameters. The maximum length or size of the MPDU among all MPDUs in the A-MPDU may be denoted as MPDU_max_length. The rest of the MPDUs may be padded to the MPDU_max_length. The example LDPC error correction encoding procedure may be repeated for all the MPDUs in the A-MPDU. In this way, each MPDU may have the same information block length (e.g. LDPC codeword length (CW length)).

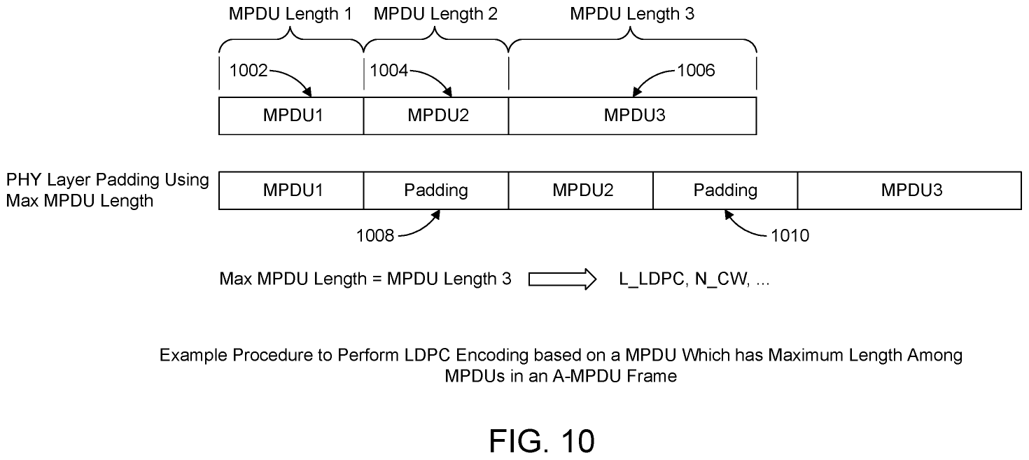

An example is given in FIG. 10. An A-MPDU may contain three MPDUs of various sizes or lengths; MPDU1 labeled as 1002 has length 1, MPDU2 labeled as 1004 has length 2, and MPDU3 labeled as 1006 has length 3. MPDU3 may have the maximum length. A MAC layer may add bit padding 1008 to MPDU1 and add bit padding 1010 to MPDU2. The bit padding is added to each MPDU so the length or size of the MPDU plus bit padding is equal to the MPDU_max_length, (i.e., MPDU3 size or length). The MPDUs and their respective bit padding are then passed to the PHY layer. In PHY, the LDPC error correction encoding procedure may be based on MPDU_max_length as shown in Method I. The padding information such as padding length, MPDU length before padding etc., may be signaled in the MAC or PHY header, or delimiter before each MPDU.

In the case where a multiple user (MU) transmission may be used, the procedure may be shown as below:

a. An AP (or other type of STA which may transmit to one or more STAs) may schedule MU transmission to M users, and each user may have an A-MPDU prepared. An MPDU_lengthₘₖ is used to denote the MPDU length for m^{th} user and k^{th} MPDU. m=1, . . . ,M and the range of k may be user dependent.
b. The AP may go through all the MPDU_lengthₘₖ and find MPDU_max_length among all the users.
c. The AP may pad each MPDU to MPDU_max_length and signal the original MPDU length or padding length in MAC header, PHY header or delimiter in A-MPDU frame.
d. For user m, the AP may perform LDPC error correction encoding procedure on each MPDU as described in Method I.

In one method, the padding mentioned above may be performed before end of frame (EOF) padding. In one method, the padding may be performed together with the MAC padding, such as pre-EOF padding so that the MPDU_length may refer the length of the MPDU pre-EOF padding and before the padding procedure defined here.

Method III

In this method, the total A-MPDU length, or APEP_length may be used as a unit to calculate LDPC error correction parameters. The calculation may follow the LDPC encoding procedure defined in the above-mentioned D3.0, Amendment 6 publication. LDPC codeword length L_{LDPC} and initial number of LDPC codewords N_{NW0} are obtained. Based on the codeword boundary, a PHY layer alignment padding may be performed together with a shortening procedure so that the information block or CW boundary may align with MPDU boundary. An LDPC encoding procedure may be performed on the aligned and padded information bits.

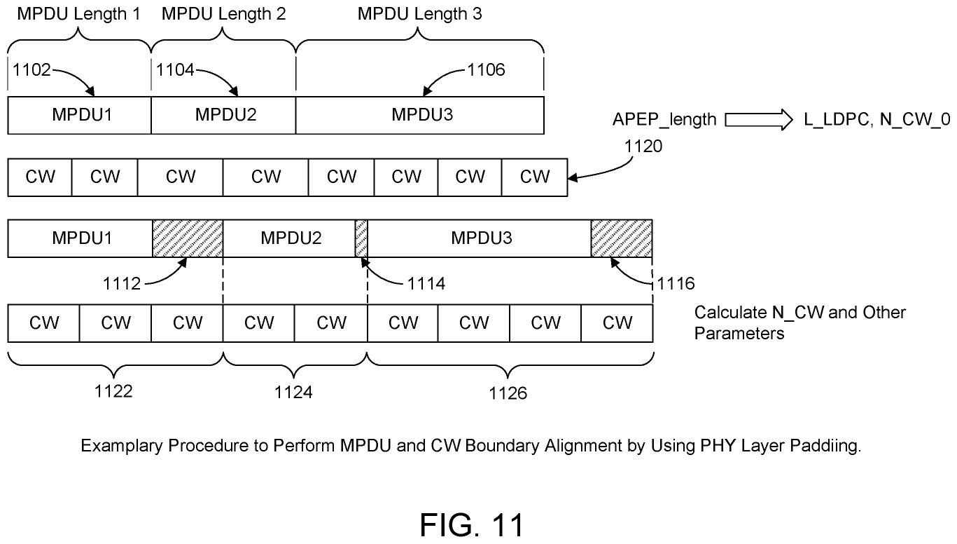

FIG. 11 is an example use of Method III. In the specific example of FIG. 11, MPDUs have various sizes (lengths); a MPDU1 labeled as 1102 has an initial length 1, MPDU2 labeled as 1104 has an initial length 2, and MPDU3 labeled as 1104 has an initial length 3. The multiple original information blocks labeled as codewords (CWs) associated with the three MPDUs is shown as 1120. Bit padding may be performed on each MPDU. Bit padding 1112 may be made for MPDU1, bit padding 1114 may be made for MPDU2, and bit padding 1116 may be made for MPDU3. One example result is that a group of three information blocks or CWs 1122 may result representing MPDU1 plus padding 1112, a second group of two information blocks or CWs 1124 may result representing MPDU2 plus padding 1114, and a third group of four information blocks or CWs 1126 may result representing MPDU3 plus padding 1116. Note that the various MPDUs have been padded to correspond (align) with the information block (CW) boundaries.

Exemplary alignment padding procedure for SU transmission is given below (assuming K MPDUs in the A-MPDU):
1. Calculate initial number of OFDM symbols for the PPDU using APEP_length as shown in the above-mentioned D3.0, Amendment 6 publication.
2. Following the calculation given in the above-mentioned D3.0, Amendment 6 publication. one LDPC codeword length, L_{LDPC} is selected to encode, and initial number of LDPC codewords are calculated as N_{CW,0}. The information bit length for each LDPC codeword is R·L_{LDPC}, where R is the coding rate.
3. For k^{th} MPDU (k=1, . . . , K) with MPDU_lengthₖ, calculate number of LDPC codewords for the MPDU:

$${N}_{CW , k} = \{ \begin{matrix}⌈ \frac{8 \cdot {MPDU\_length}_{k} + {N}_{SERVICE}}{R \cdot {L}_{LDPC}} ⌉ & k = 1 \\ ⌈ \frac{8 \cdot {MPDU\_length}_{k}}{R \cdot {L}_{LDPC}} ⌉ & k > 1\end{matrix} . \qquad a$$

4. For k^{th} MPDU (k=1, . . . , K), compute the number of shortening bits, N_{shrt,k}, to be padded to the data bits before encoding. Shortening bits are used in LDPC encoding process. An LDPC encoder would encode K information bits to N coded bits. If the raw bits/information bits are less than K, then the encoder would insert zeros to make them K. These inserted bits are called shortening bits. After encoding, the shortening bits are removed. The number of shortening bits may be computed as:
   a. N_{shrt,k}=max(0, N_{CW,k}·R·L_{LDPC})−8MPDU_lengthₖ)
   b. Note the shortening bits may be evenly distributed over all N_{CW,k} codewords with the first N_{shrt,k} mod N_{CW,k} codewords shortened 1 bit more than the remaining codewords within the MPDU
5. Calculate number of coded bits after removing shortening bits for the k^{th} MPDU
   a. N_{cb,k}=N_{CW,k}·L_{LDPC}·N_{shrt,k}
6. Repeat the MPDU based procedure for all the MPDUs. Calculate the estimated total number of coded bits for MPDUs using below equation
   a. N_{cb}=Σₖ₌₁^{K}N_{cb,k}
7. The updated estimated number of OFDM symbols may be calculated as below. N_{cbps} is the number of coded bits per OFDM symbol.

$${N}_{SYM , init} = ⌈ \frac{{N}_{cb}}{{N}_{cbps}} ⌉ . \qquad a$$

8. The number of coded bits left in the last OFDM symbol is
   a. N_{excess}=mod(N_{cb},N_{cbps})
9. The initial pre-FEC padding factor value or aᵢₙᵢₜ may be calculated as

$${a}_{init} = \{ \begin{matrix}4 , & if {N}_{excess} = 0 \\ min ( ⌈ \frac{{N}_{excess}}{{N}_{CBPS , short}} ⌉ , 4 ) & otherwise\end{matrix} . \qquad a$$

b. Here N_{CBPS,short}, is the number of coded bits per symbol per allocated resource unit (RU) divided by 4.
10. Follow the procedure defined in the above-mentioned D3.0, Amendment 6 publication. to calculate the number of information bit N_{pld} and number of available coded bits N_{avbits} for the entire PPDU considering the pre-FEC padding segment in the last OFDM symbol. Then calculate the number of information bit N_{pld,last} and number of available coded bits N_{avbits,last} for the last MPDU as
   a. N_{pld,last}=N_{pld}−Σₖ₌₁^{K-1}8·MPDU_lengthₖ−N_{SERVICE}
   b. N_{avbits,last}=N_{avbits}−Σₖ₋₁^{K-1}N_{cb,k}
11. Using N_{pld,last} and N_{avbits,last} to perform shortening for the last MPDU.
12. Perform puncturing. In one method, the punctured bits may be evenly distributed to all the CWs across all the MPDUs. In one method, puncturing may be performed per MPDU based.
13. Calculate N_{SYM} and a factor and continue encoding procedure following the above-mentioned D3.0, Amendment 6 publication.

For multi-user (MU) transmissions, the following procedure may be used: Following procedures defined in steps 1-7 above for all the users to calculate the following per user parameters:
a. Initial number of OFDM symbols per user N_{SYS,init,u}

Determine the user with the maximum encoded packet duration and set N_{SYS,tnit} and aᵢₙᵢₜ as the values with the user (following procedures defined in the above-mentioned D3.0, Amendment 6 publication.).

For the last MPDU for all the users, use N_{SYS,init} and aᵢₙᵢₜ to perform bit padding and shortening as explained in steps 8-11 above.

Calculate N_{SYM} and a factor and continue encoding procedure following the above-mentioned D3.0, Amendment 6 publication.

Information Block/Codeword Length Selection

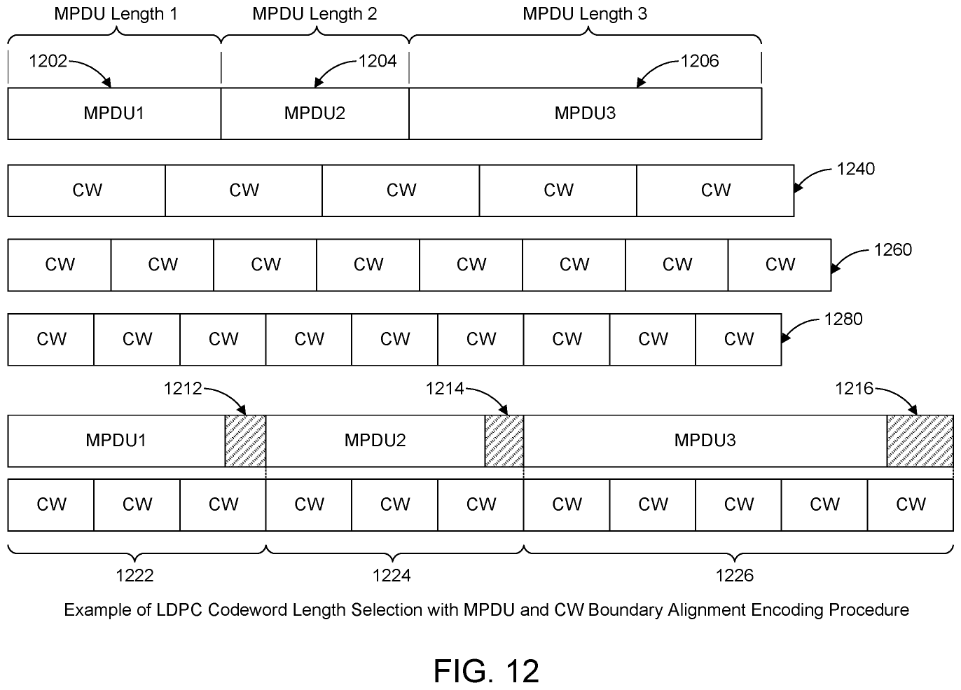

In this method, the information block length, such as the LDPC error correction codeword length, selection may be performed. FIG. 12 shows an example of information block (e.g. LDPC codeword length) selection with MPDU and information block (CW) boundary alignment encoding procedure. In this example using the LDPC example, a 3 different LDPC codeword lengths (information block lengths) are used. A predefined/predetermined codeword length selection criteria may be set. For example, the information block length (codeword length) may be chosen which minimize the number of MPDU and CW boundary alignment padding/shortening bits. After codeword length selection, an encoding procedure may be performed as shown in before mentioned methods.

In FIG. 12, three different MPDU sizes are depicted; a MPDU1 labeled as 1202 has an initial length 1, MPDU2 labeled as 1204 has an initial length 2, and MPDU3 labeled as 1204 has an initial length 3. Three different information block (CW) length sets are shown. A first CW set 1240 may be compared to a second CW set 1260 and a third CW set 1280. Each CW set has different lengths and numbers of information blocks (CWs). In one example, the individual CW length of CW set 1280 is selected as a basis for determining the added bit padding to apply to each MPDU. Bit padding 1212 may be applied to MPDU1, bit padding 1214 may be applied to MPDU2, and bit padding 1216 may be applied to MPDU3. One example result is that a group of three CWs 1222 may result representing MPDU1 plus padding 1212, a second group of three CWs 1224 may result representing MPDU2 plus padding 1214, and a third group of four CWs 1226 may result representing MPDU3 plus padding 1216.

Methods to Minimize the Number of Bits for Alignment Padding:
1. Go through all the possible LDPC codeword length, L_{LDPC,m}, m=1, . . . , M where M is the possible number of LDPC codeword lengths defined, and calculate the number of LDPC codewords for the k^{th} MPDU:

$${N}_{CW , k , m} = \{ \begin{matrix}⌈ \frac{8 \cdot {MPDU\_length}_{k} + {N}_{SERVICE}}{R \cdot {L}_{LDPC , m}} ⌉ & k = 1 \\ ⌈ \frac{8 \cdot {MPDU\_length}_{k}}{R \cdot {L}_{LDPC , m}} ⌉ & k > 1\end{matrix} . \qquad a$$

2. For k^{th} MPDU (k=1, . . . ,K), compute the number of shortening bits, N_{shrt,k,m}, to be padded to the data bits before encoding:
b. N_{shrt,k,m}=max(0,N_{CW,k,m}·R·L_{LDPC,m})−8MPDU_lengthₖ)
   3. Calculate the total number of shortening bits for LDPC codeword length m:

$${N}_{shrt , m} = {\sum }_{k = 1}^{K} {N}_{shrt , k , m}$$

4. Choose m^{th} LDPC codeword length which has minimum N_{shrt,m}

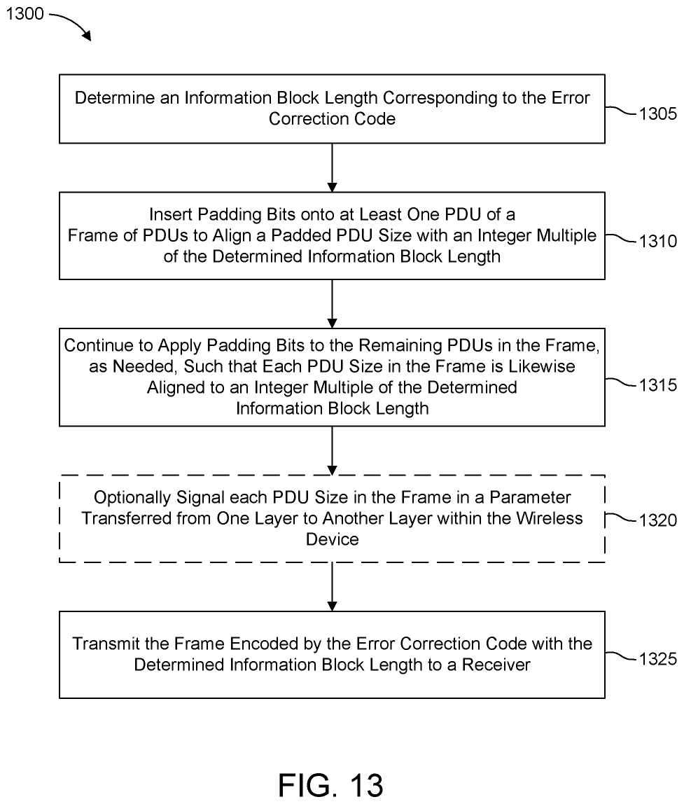

The concepts and features for embodiment 1 as described above as Method I, Method II, Method III, and Codeword Length Selection may be combined in order to construct an A-MPDU with one or more padded MPDU sizes that align with units of information block lengths. Furthermore, the above concepts may be applied in a layer agnostic manner. That is, regardless of any particular structural layer, the information block (codeword) length selection and data block unit (protocol data unit) size are determined, and the alignment of data unit size and information block length multiple may be applied. Thus, a data unit of a protocol data unit (PDU) size may be used in the above methods to construct a plurality of PDUs in a frame of PDUs to be transmitted. FIG. 13 is an example method to align sizes of PDUs in a constructed frame of a plurality of PDUs with lengths of corresponding information blocks of an error correction code for a wireless transmission.

In FIG. 13, at 1305, a wireless device, such as a wireless station (STA) or access point (AP) may determine an information block length corresponding to the error correction code. As described herein above, an information block length may also be termed a codeword length. The information block may be used to encode error correction code parameters. At 1310, the wireless device may insert padding bits onto at least one of the PDUs of the frame of a plurality of PDUs to align a padded PDU size with an integer multiple of the determined information block length. For example, as indicated in the example of FIG. 11, padding bits 1112 may be added/appended/concatenated to a first PDU (for example MPDU1) to accommodate an information block length (codeword length). In the example of FIG. 11, padding bits 1112 are added to a first PDU to accommodate an integer multiple of CWs 1112. In the example of FIG. 11, the integer number of CWs is three in 1122. However, other CW integer numbers may result from the padding bits added to a PDU. This action of inserting padding bits essentially aligns the padded PDU size to be that of whole number of information block lengths (CW lengths).

Returning to FIG. 13, at 1315, the action at 1310 to align a PDU size with a whole number of CW lengths may be repeated or continued to be applied as needed to the remaining PDUs in the frame of a plurality of PDUs. Thus, each PDU size in the multi-PDU frame may be likewise aligned to an integer multiple of the determined information block length. For example, in FIG. 11, a next PDU (for example MPDU2) may be padded with bits 1114 to generate a PDU size of a whole number (two CW as in 1124). A similar padding of bits 1116 may be applied, as needed, to a next PDU (for example, MPDU3) to align the next PDU size (such as the MPDU3 size) to that of an integer (whole number) multiple of CWs. In the example of FIG. 11, the size of a next PDU (such as MPDU3) and the padding bits 1116 is aligned to be four CW lengths as in 1126. It is noted that the actions at 1310 and 1315 may be considered as a single alignment process or a multiple step alignment process. It is also possible that one or more PDUs in a constructed (resulting) frame of multiple PDUs to be transmitted (such as an A-MPDU to be transmitted) may not need padding bits to be aligned with an integer number of information blocks.

Returning to FIG. 13, at 1320, the wireless device may optionally signal each PDU size in the constructed frame of PDUs to be transmitted to a different structural layer within the wireless device, if applicable. For example, this signaling may be transferred in a parameter from a medium access control layer to a physical layer within the wireless device. Thus, the wireless device may reasonably use a mechanism to prepare for a transmission of the constructed frame of PDUs by noting the size of each resultant PDU size in the constructed frame of multiple PDUs. Each resultant PDU size (padded PDU size) in the constructed frame to be transmitted is the original PDU length plus any padding bits, (i.e. padding bits added if and as needed), to align with whole information block lengths as described above. In some instances, an original PDU length may not need padding bits to be equal to an information block/codeword length for use in the frame to be transmitted.

In FIG. 13, at 1325, the wireless device may transmit the constructed frame of a plurality of PDUs (such as an A-MPDU frame) encoded by the error correction code with the determined information block length to a wireless receiver. This action is used by the wireless device to communicate the constructed multi-PDU frame to a wireless receiver on a network, such as an IEEE 802.11 or another standard-based based wireless network. The information transmitted may include not only the constructed multi-PDU frame but also the associated information blocks (codewords) which may be used by the receiver to error correct the received PDUs in the constructed and transmitted multi-PDU frame.

In one embodiment, the information block length corresponds to a length used as a unit length for a low density parity check code for an error correction code. The information block length may be a single information block length for the construction of each PDU size in the constructed frame of a plurality of PDUs. In one particular instance, the insertion of padding bits onto at least one PDU may result in padding bits added such that each PDU in the constructed frame of PDUs to be transmitted are of equal size. In one particular embodiment example, the insertion of padding bits into at least one PDU of a plurality of PDUs may be the insertion of padding bits into at least one MPDU in an A-MPDU frame.

In an embodiment, signaling of each PDU size in the constructed frame of PDUs may occur in a parameter that is signaled from one layer to another layer in the wireless device. In one example, the signaling of each PDU size of the constructed frame of PDUs may be a signaling from a MAC layer to a PHY layer within the wireless device and may be accomplished using a TXVECTOR parameter. In an embodiment, the wireless device in the method of FIG. 13 may transmit the constructed frame of PDUs encoded by the error correction code, such as an LDPC code, to a receiver on the same network as the wireless device by signaling each PDU size in the constructed frame of PDUs in a preamble of the wireless transmission. In another embodiment, the wireless transmission of the multi-PDU frame encoded by the error correction code to a receiver may be accomplished by also using an extra symbol segment field in a preamble of the wireless transmission. The extra symbol segment field may be a low density parity check extra symbol segment field. In another embodiment, transmitting the constructed frame of multiple PDUs encoded by the error correction code to a receiver may be accomplished by also transmitting a pre-forward error correction padding factor field in a preamble of the wireless transmission. It is noted that the wireless transmission of a constructed frame of PDUs may be accomplished using a STA or an AP in a wireless communication system.

### Embodiment 2: Scrambler & Identifying Failed Sections

Methods and procedures disclosed here may be used to address objective/problem 2. As noted above, the utility of the methods disclosed herein need not be limited to particular layers of a wireless device. Thus, structures such as MPDUs and A-MPDUs may be considered protocol data units and frames of a plurality of PDUs respectively. In the following description, embodiment examples involving MPDUs and A-MPDUs are used as a specific example, but the concepts need not be limited to specific layers.

The information blocks referred to as CW described in the sections below could also be a group of CWs (CW group) such that each group is a unit for feedback and retransmission. Each CW or CW group may have an additional CRC to verify the correctness of the received bits.

In the objective/problem statement, two methods are identified for the Tx/Rx to identify the failed sections in the feedback and retransmission, the first is based on the offset din the original A-MPDU, the 2nd is based on an receiver specified identifier (HARQ seq #) which has the numbering space proportional to the HARQ buffer size.

In the first method, the retransmission needs to signal an identity of the original MPDU, and the offset d. In the 2nd method (If there is no feedback, the transmitter backs off and retransmits the original A-MPDU), the retransmission signals a HARQ seq #, from which the receiver derives the context (e.g. scrambler state, a pointer to the HARQ buffer, CW size, decoded bits which has not been assembled to MPDU(s) before or after the CW associated with the HARQ seq #).

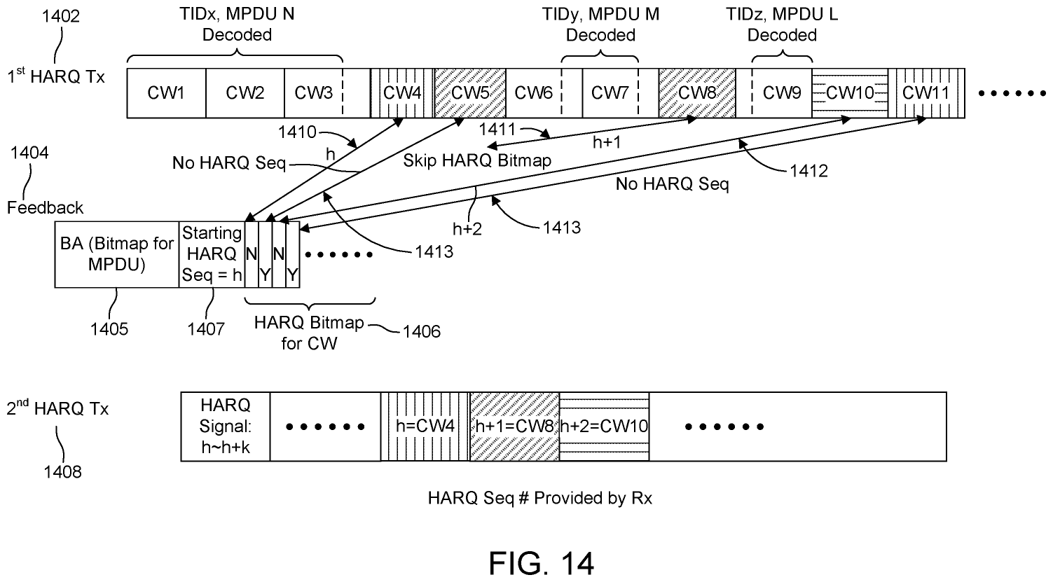

An example is provided in FIG. 14 to illustrate the 2^{nd} method. FIG. 14 is an example of HARQ sequence # provided by a receiver (Rx). The method is independent of MPDU to information block (CW) boundary alignment, but the example is illustrated as not aligned to be general. In this example, in the 1^{st} HARQ transmission 1402, CW1, CW2, CW3, CW5, CW6, CW7, CW9, and CW11 are decoded. Traffic identifier x (TID x) and MPDU N are associated with portions of CW1, CW2 and CW3. TID y and MPDU M are associated with portions of CW6 and CW7. TID z and MPDU L are associated with portions of CW9. The receiver uses the respective decoded CWs to assemble MPDU N, MPDU M, MPDU L and reflects this in the block acknowledgement (BA) 1405 to the transmitter. The BA 1405 is shown in FIG. 14 as Feedback 1404 related to the 1^{st} HARQ Tx 1402. The BA 1405 is a bitmap for acknowledgement of the MPDUs.

In the feedback 1404, the receiver adds a HARQ bitmap 1406 for the CWs, in which each bit is associated with a CW not associated by any of the successfully received MPDUs (i.e. MPDU N, MPDU M, MPDU L), except (optionally) the CW which has both CWs before and after both occupied by successfully received MPDU (e.g. CW8). For example, CW8 has no corresponding bit in the HARQ bitmap 1306 because CW8 lies between two successfully received MPDUs; MPDU M and MPDU L.

Before the HARQ bitmap 1406, the receiver identifies a starting HARQ seq # h 1407. In the above example, the failed CWs (CW4, CW8, CW10) are assigned by the receiver HARQ seq # h, h+1, h+2 respectively. See items 1410, 1411, and 1412 respectively. Those successful CWs but not occupied by a successful MPDU (marked as 1414 with No HARQ seq in FIG. 14), such as CW5 and CW11, are not identified by a HARQ seq # but the decoded bits are stored locally in the receiver for reassembly. In the successful CWs partially occupied by successful MPDUs, such as CW3, CW6, CW7, and CW9, the HARQ CW bitmap bits are not associated with the successful MPDUs are stored locally and linked to the CW (either info bits from a locally stored successful CW, or a failed CW with HARQ seq #) before or after the CW related bits in the HARQ CW bitmap. In the HARQ CW bitmap 1406, the designations “N” and “Y” are No and Yes merely indicate CW acknowledgement. In practice, another designation, such as a digital designation, may be used. In the feedback 1404, there are two sets of acknowledgements. The first set is MPDU level acknowledgements (1405 bitmap for MPDU) and the second set is CW level acknowledgements (1406 bitmap for CW). For MPDU level acknowledgement, a traditional IEEE 802.11 BA mechanism and format may be used. The CW level acknowledgement 1406 carries CW acknowledgements which are not covered by positive MPDU level acknowledgement. By receiving the HARQ Feedback 1404, the HARQ initiator/transmitter may identify the failed CWs. In this example, they are CW4, CW8 and CW10. The HARQ initiator/transmitter may retransmit the failed CWs and indicate the HARQ seq number range as [h, h+k]. Here k+1 is the total number of failed CWs.

In the HARQ bitmap for CW 1406, each bit status may signal the status of a CW not occupied by a successful MPDU. Alternatively, for a more compact bitmap, each bit signals the status of a CW not occupied by a successful MPDU, and the CW is not the only CW between 2 CWs which are occupied by successful MPDUs.

For example, the status of CW 8 may not be signaled in the HARQ bitmap, because the transmitter knows that there are MPDUs between MPDU M and MPDU L not successful based on the ‘bitmap for MPDU’, and CW 8 is the only CW between MPDU M and MPDU L. The transmitter can derive the failure of the CW without explicit signaling.

In the above example, the HARQ bitmap identifies the status of CW4, CW5, CW10, and CW11. The transmitter understands the 1^{st} bit in the HARQ bitmap 1406 is associated with CW4 because CW4 is the first CW not occupied by a successful MPDU (identified in the ‘bitmap for MPDU’ 1405 in the BA in Feedback 1404). The transmitter knows the 3^{rd} bit in the HARQ bitmap 1406 identifies CW10 because CW10 is the 4^{th} CW not occupied by a successful MPDU, and before CW10, there is a CW8 which does not require a bit in the bitmap.

In the alternative 2^{nd} HARQ Tx 1408 in FIG. 14, the transmitter identifies the retransmitted CWs based on the HARQ seq #, h˜h+k. The receiver uses the context associated with a HARQ seq #, to find the LLRs stored in the HARQ buffer, to combine and decode the CW. If successful, the receiver uses the HARQ seq # context to find the bits before or after the CW for reassembly.

The HARQ bitmap 1406 may only signal the status of a set of CWs which cannot be assembled to an MPDU, and for which the receiver has buffered LLRs or decoded partial MPDUs. The receiver may not have the memory capacity to buffer the LLRs of all failed CWs. For those not buffered, they are not identified in the HARQ bitmap 1406. The transmitter identifies the failed MPDUs whose CW positions correspond to the CWs explicitly or implicitly identified in the HARQ bitmap 1406, to perform HARQ retransmission. For those failed MPDUs whose CW positions do not correspond to the CWs explicitly or implicitly identified by the HARQ bitmap 1406, the transmitter may not perform HARQ retransmission. The bitmap in this case may represent the status of a subset of all CWs which do not contain successful decoded MPDUs and is denoted as a shortened bitmap. A signaling may be provided in the feedback to indicate the CW position in the PPDU for the shortened bitmap. For example, the bitmap has only 2 bits corresponding to the CW10 and CW11. The signaling in the feedback indicates the starting position of the bitmap as CW10 and the length is 2. The CWs not explicitly signaled by this shortened bitmap, e.g. CW4, CW5, and CW8, are interpreted by the transmitter as soft-bits not stored by the receiver for these CWs. For the MPDUs contained in these CWs without buffered soft-bits (e.g. CW4, CW5, and CW8), the transmitter may perform HARQ retransmission of the MPDUs, instead of performing HARQ retransmissions of the CWs. There may be more than one shortened bitmap in the feedback to represent the different portions of buffered or decoded CWs.

An alternative to the above-paragraph approach is to send the feedback as a Block Acknowledge (BA). The positions of the CWs which do not contain a successful MPDU and (not) buffered by the receiver are explicitly signaled together with the BA. For example, the additional signaling could be a bitmap for all CWs in the PPDU, with the bit value set to 1 to indicate the corresponding CW not buffered, and bit set to 0 to indicate the corresponding CW as either decoded or not decoded but buffered. In one alternative, the additional signaling may be a list of CW indices for the failed CWs which are not buffered.

Alternatively, the feedback from the receiver may be a collection of fields with each field correspond to the status of a CW. Each field may have multiple values such as successful, failure but buffered, or failure and not buffered. For example a two-bit field for a CW with ‘10’ may signal the CW (and MPDUs within) as decoded, ‘01’ may signal the CW as not decoded but its soft-bits buffered for HARQ retransmission combining, ‘00’ may signal a CW as not decoded and soft-bits not buffered.

The embodiments above still require the receiver to keep the scrambler state in the context associated with the failed sections/CWs.

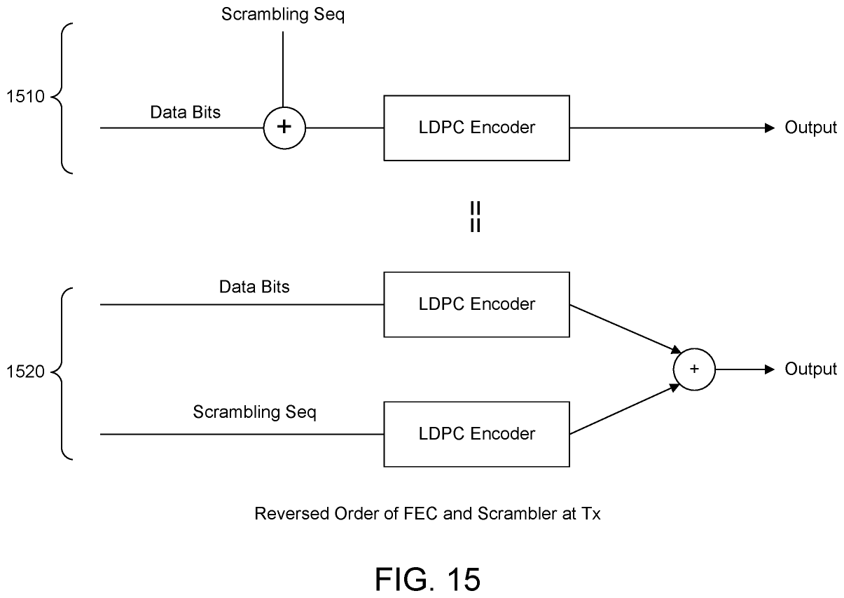

FIG. 15 depicts two views of a LDPC output using data bits and scrambling sequence from a Transmitter Tx. As shown in FIG. 15, because the LDPC encoder is linear, the order of scrambler can be reversed; i.e. scrambling can take place after encoding, and descrambling can take place before decoding. The configuration 1510 of FIG. 15 depicts a transmission procedure in a current standard, where the data bits coming from MAC layer are scrambled first. Since scrambling is a linear operation, we may express it as the data bits add with a scrambling sequence. The scrambling sequence may be generated by passing all zero bits to scrambler with a given scrambling seed. Then the summation, i.e., scrambled bits, are input to the LDPC encoder. While in the configuration 1520 of FIG. 15 the data bits and scrambling sequence are passed to the LDPC encoder separately, and a summation is performed at the output of the LDPC encoder. The two operations are equivalent in the sense that the same input, i.e., the data bits, generate the same output.

Based on this property, the HARQ retransmissions of a CW/section can be sent with different scrambling sequence without requiring the receiver to remember the scrambler state in the original A-MPDU.

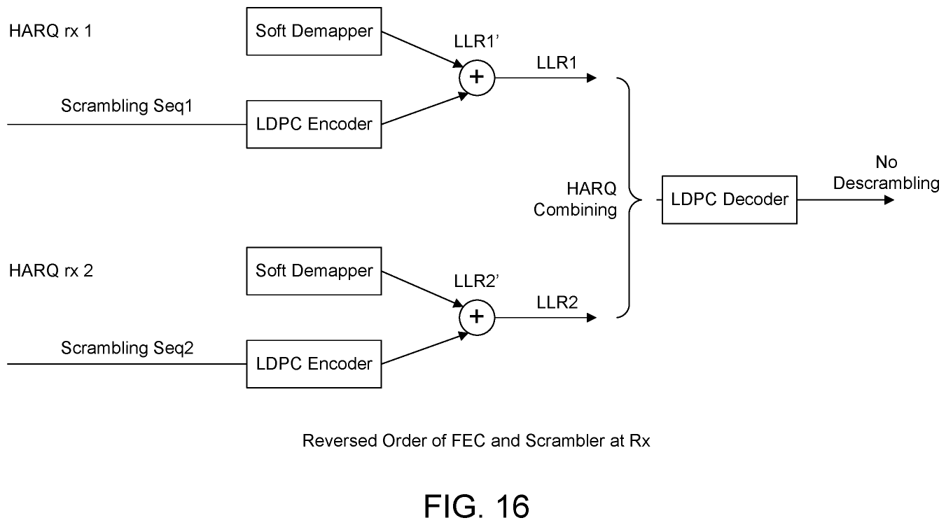

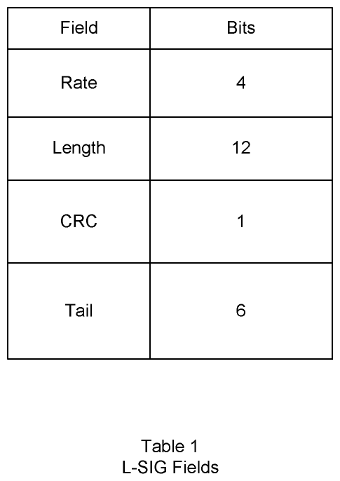

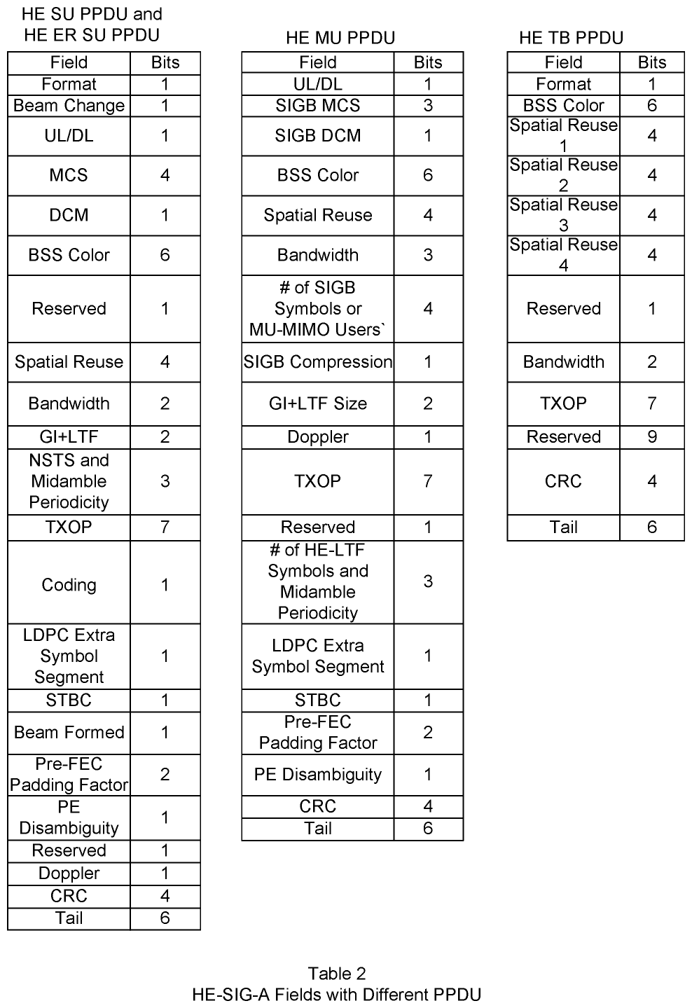

FIG. 16 depicts a block diagram showing possible reversed order of FEC and scrambler at a receiver Rx. In FIG. 16, the log-likelihood ratio element n′ (LLRn′) received in the n-th HARQ transmission, can be pre-descrambled before combing with the previous LLR, decoding and possibly storing to the HARQ buffer. The pre-descrambling is based on the LLRn′ from the soft demapper and an encoded scrambling sequence. The encoded scrambling sequence is generated by encoding the scrambling sequence which may be seeded differently from previous HARQ transmissions. The pre-descramble operation, for example, can be an operation of reversing the sign of LLRn′, if the corresponding bit in the encoded scrambling sequence is 1.

Based on the above mechanism, the receiver (Rx) no longer needs to remember the scrambler state, and the transmitter can signal a single scrambling seed for the entire retransmitted A-MPDU which possibly consists of multiple HARQ retransmitted sections from different previous A-MPDUs with different scrambler initiations. The single scrambling seed can be signaled in the PPDU header instead of in the payload.

Alternatively, each retransmitted HARQ section may be scrambled based on a scrambling seed derived from the HARQ seq # or an identifier of the HARQ (re-)transmission. With this alternative, no additional overhead of the scrambling seed is needed.

Alternatively, the scrambling sequence may be applied after the FEC encoder. This makes HARQ retransmission independent of the scrambling sequence of the original transmission. Furthermore, as newer amendments signaling network allocation vector (NAV) outside of the payload, a 3rd party STA no longer needs to decode unintended PPDUs for observing NAV. Scrambling after FEC randomizes the interference which would not have the processing gain provided by the FEC compared to the desired signal.

Alternatively, the scrambling sequence may be based on the BSS identity, and possibly with other quantities to construct a final scrambling sequence. The scrambling may be performed before or after the FEC encoding.

### Embodiment 3: Buffer Limited HARQ Transmission

HARQ Buffer Negotiation

As noted above, the utility of the methods disclosed herein need not be limited to particular layers of a wireless device. Thus, structures such as MPDUs and A-MPDUs may be considered protocol data units and frames of a plurality of PDUs respectively. In the following description, embodiment examples involving MPDUs and A-MPDUs are used as a specific example, but the concepts need not be limited to specific layers. In one method, the HARQ originator and HARQ responder may negotiate HARQ buffer size before HARQ transmissions. The negotiation may be capability based and static. For example, the HARQ buffer related information may be transmitted in a HARQ capability information element during association.

In one method, the HARQ buffer Negotiation may be before a HARQ transmission or a sequence of HARQ transmissions or a TXOP. For example, the HARQ buffer Negotiation may be part of existing block ACK Negotiation through an add block acknowledge (ADDBA) request/response frame exchange. In this case, the negotiated HARQ buffer size may be applied to the block ACK frame exchange session, or the HARQ buffer Negotiation may before one or more HARQ processes using newly defined control/management frames.

The HARQ buffer related information may include:

a. Buffer size
b. Buffer size for each Traffic ID (TID)
c. Transmit buffer size and receive buffer size

The size may be a quantized value of the real buffer size available. Alternatively, there may be predefined several level of buffer sizes. The device may indicate the level for which the real device buffer size is just above the fixed level value.

HARQ Feedback with Buffer Indication

There may be difficulties for the HARQ originator to conclude whether a particular failed HARQ unit is buffered. In this embodiment, a buffer indication may be included in HARQ feedback so that HARQ originator may perform retransmission properly.

HARQ receiver/responder may choose not to buffer the received HARQ unit if:

a. Receiver may not have enough capability to buffer the HARQ unit
b. Receiver may detect strong collision or high interference on the HARQ unit
c. Receiver may detect the receive Signal-to-Interference-plus-Noise Ratio (SINR) for the HARQ unit is below a predefined/predetermined threshold

In one method, both HARQ-ACK bitmap and HARQ buffer indication bitmap may be included in the HARQ feedback/ACK. Both bitmaps may be with a fixed length/size. The bitmap size may be predefined/predetermined/negotiated. For example, the size may be negotiated when the HARQ session is set up between the originator(s) and responder(s). A HARQ-ACK bitmap may indicate if the HARQ unit is successfully decoded. The HARQ buffer indication bitmap may indicate if the HARQ unit is buffered. For example, a HARQ feedback/ACK may carry acknowledgement for 8 HARQ units and HARQ unit 1, 3, 5 are not successfully decoded, and HARQ unit 1 and 3 are buffered. Then the HARQ-ACK bitmap may be 8-bits long with [1 0 1 0 1 0 0 0] and HARQ buffer indication bitmap may be [1 0 1 0 0 0 0 0].

In one method, both HARQ-ACK bitmap and HARQ buffer indication bitmap may be included in the HARQ feedback/ACK. HARQ-ACK bitmap may indicate if the HARQ unit is successfully decoded and may be with a fixed length. The HARQ-ACK bitmap size may be predefined/predetermined/negotiated. For example, the size may be negotiated when the HARQ session is set up between the originator(s) and responder(s). The HARQ buffer indication bitmap may indicate if the HARQ unit is buffered. The HARQ buffer indication bitmap size may depend on the values in HARQ-ACK bitmap. For example, a HARQ feedback/ACK may carry acknowledgement for 8 HARQ units and HARQ units 1, 3, 5 are not successfully decoded, and HARQ unit 1 and 3 are buffered. Then the HARQ-ACK bitmap may be 8-bit long with [1 0 1 0 1 0 0 0] and HARQ buffer indication bitmap may be [1 1 0] which may be corresponding to the failed HARQ units.

The originator may need to retransmit failed HARQ units, e.g. unit 1, 3, 5 in the above example. However, HARQ unit which may not be buffered (unit 5 in above example) may be transmitted with self-decodable version and/or may be with lower MCS since combination for the unit may not be possible.

HARQ Buffer Resolution

In this method, HARQ buffer size may be fixed for a STA, however, the STA may be able to choose the resolution for stored values and adjust the HARQ buffer usage. For example, the HARQ buffer size may be M bits. The HARQ buffer may be used to store soft decoded values, i.e., LLRs. If each LLR value may use 8 bits to represent, then the buffer may be used to store M/8 LLR values. If each LLR value may use 6 bits to represent, then the buffer may store M/6 LLR values. Different LLR value resolution may introduce different capacity for HARQ unit storage. In the proposed scheme, HARQ buffer resolution may be exchanged between the originator(s) and responder(s) together with HARQ buffer size.

In one method, HARQ buffer resolution may be part of HARQ buffer negotiation process introduced in the section entitled HARQ Buffer Negotiation.

In one method, multiple resolution levels may be predefined/predetermined/negotiated. The originator may indicate the HARQ transmission may need to be buffered using one resolution level. The originator may calculate based on receiver's HARQ buffer size and suggested resolution level to adjust the transmitted packet size. The responder may follow the instruction of the originator to set its buffer resolution. The HARQ buffer resolution may be carried in HARQ Negotiation frames exchanged before HARQ transmission. Or it may be carried in MAC header/PHY header together with HARQ transmission.

In one method, the responder/receiver may be able to lower the HARQ buffer resolution and report that to the originator. For example, a responder/receiver may fail to detect HARQ unit n, and store that with HARQ buffer resolution m. The responder/receiver may report the information to the originator in the HARQ feedback.

In one method, multiple resolution levels may be predefined/predetermined/negotiated based on the QoS parameters. For example, traffic with high reliability requirement may use higher resolution.

The following documents are included for reference material and are incorporated by reference as indicated herein.
[1] IEEE Std 802.11™-2016: Wireless LAN Medium Access Control (MAC) and Physical Layer (PHY) Specifications
“IEEE P802.11ax™/D3.0, Amendment 6: Enhancements for High Efficiency WLAN”, 2018.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the methods, apparatuses and systems provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM″)) or non-volatile (e.g., Read-Only Memory (ROM″)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of” multiples of the items and/or the categories of items, individually or in conjunction with other items and/or other categories of items. Moreover, as used herein, the term “set” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

What is claimed:

1. A method to transmit data from a wireless apparatus, the method comprising:
determining an information block length corresponding to the error correction code;
inserting padding bits into at least one protocol data unit, PDU, of a plurality of PDUs such that a padded PDU size is an integer multiple of the determined information block length, wherein each PDU in a frame of PDUs to be transmitted comprises a PDU size that is an integer multiple of the determined information block length, and wherein PDU sizes are aligned with corresponding information blocks; and
transmitting the frame encoded by the error correction code with the determined information block length to a wireless receiver.

2. The method of claim 1, wherein determining an information block length corresponding to the error correction code comprises determining an information block length corresponding to a low density parity check code.

3. The method of claim 1, wherein inserting padding bits into at least one PDU of a plurality of PDUs, comprises inserting padding bits into at least one Medium Access Control Protocol Data Unit, MPDU, in an aggregated MPDU, A-MPDU, frame.

4. (canceled)

5. The method of claim 1, further comprising, before transmitting:
signaling each PDU size in the frame of PDUs to be transmitted in a TXVECTOR parameter.

6. The method of claim 1, wherein transmitting the frame encoded by the error correction code to a wireless receiver comprises signaling each PDU size in a preamble of a wireless transmission.

7. The method of claim 1, wherein transmitting the frame encoded by the error correction code to a wireless receiver comprises using an extra symbol segment field in a preamble of a wireless transmission.

8. The method of claim 7, wherein the extra symbol segment field comprises a low density parity check extra symbol segment field.

9. The method of claim 1, wherein transmitting the frame encoded by the error correction code to a wireless receiver comprises transmitting a pre-forward error correction padding factor field in a preamble of a wireless transmission.

10. A wireless apparatus comprising circuitry, including a transmitter, a receiver, a processor, and memory, to transmit data, the wireless apparatus configured to:
determine an information block length corresponding to the error correction code;
insert padding bits into at least one protocol data unit, PDU, of a plurality of PDUs such that a padded PDU size is an integer multiple of the determined information block length, wherein each PDU in a frame of PDUs to be transmitted comprises a PDU size that is an integer multiple of the determined information block length, and wherein PDU sizes are aligned with corresponding information blocks; and
transmit the frame encoded by the error correction code with the determined information block length to a wireless receiver.

11. The wireless apparatus of claim 10, wherein the determination of the information block length corresponding to the error correction code comprises a determination of the information block length corresponding to a low density parity check code.

12. The wireless apparatus of claim 10, wherein the insertion of padding bits onto at least one PDU of a plurality of PDUs comprises inserting padding bits into at least one Medium Access Control Protocol Data Unit, MPDU, in an aggregated MPDU, A-MPDU, frame.

13. (canceled)

14. The wireless apparatus of claim 10, further comprising the wireless apparatus configured to:
signal each PDU size in the frame of PDUs to be transmitted in a TXVECTOR parameter.

15. The wireless apparatus of claim 10, wherein the frame is transmitted with signaling of each PDU size in a preamble of the transmission.

16. The wireless apparatus of claim 10, wherein the frame is transmitted using an extra symbol segment field in a preamble of the transmission.

17. The wireless apparatus of claim 16, wherein the extra symbol segment field comprises a low density parity check extra symbol segment field.

18. The wireless apparatus of claim 10, wherein the frame is transmitted using a pre-forward error correction padding factor field in a preamble of the transmission.

19. The wireless apparatus of claim 10, wherein the wireless apparatus is one of a wireless station or a wireless access point.

20. A non-transient computer readable storage medium comprising instructions which when executed by a computer cause the computer to carry out the method comprising:
determining an information block length corresponding to the error correction code;
inserting padding bits into at least one protocol data unit, PDU, of a plurality of PDUs such that a padded PDU size is an integer multiple of the determined information block length, wherein each PDU in a frame of PDUs to be transmitted comprises a PDU size that is an integer multiple of the determined information block length, and wherein PDU sizes are aligned with corresponding information blocks; and
transmitting the frame encoded by the error correction code with the determined information block length to a wireless receiver.
